(19) United States
(12) Patent Application Publication
(10) Pub. No.: US 2011/0145641 A1
(43) Pub. Date: Jun. 16, 2011

(54) Method and system for VoiceXML quality assurance.

(76) Inventor: Daniel D Evans, (US)

(21) Appl. No.: 12/635,963

(22) Filed: Dec. 11, 2009

(51) Int. Cl. G06F 11/36

(52) U.S. Cl. 714/27; 714/E11.207

(57) ABSTRACT

A software quality assurance tool (“IVRT”) for VoiceXML applications is described. IVRT makes speech and telephony irrelevant to the testing of VoiceXML logic. IVRT follows a machine-readable “Test Plan” to execute the logic of an application. The Plan provides the results of telephony interactions. Testing is done without live callers, and runs at computer speed. A Plan contains any number of calls, to guide the application execution through all logic paths. The tool executes the application in a live environment with respect to all non-telephony functions, particularly web interactions, to test the application's web logic. IVRT executes multiple threads, acting as simultaneous callers, to provide controlled load web logic testing. The tool summarizes Plan “coverage”. For regression testing, IVRT tests an updated application with its original Test Plan and compares the log to previous logged output. Differences indicate potential regression failures.

### BRIEF DESCRIPTION OF THE DRAWINGS

FIG. 1A is a block diagram of a computer system having features required by an embodiment of the invention.

FIG. 1B is a block diagram depicting the execution of the invention, its input Test Plan and VoiceXML application, and its output log and reports.

FIG. 1C is a sample Test Plan. This is presented as illustrative of the Test Plan contents. The meaning of the statements in FIG. 1C is not important to the exposition of the invention.

### DETAILED DESCRIPTION OF A PREFERRED EMBODIMENT

In the following description, well-known elements are presented without detailed description in order not to obscure the present invention in unnecessary detail. For the most part, details unnecessary to obtain a complete understanding of the present invention have been omitted since such details are within the understanding of persons skilled in the relevant art.

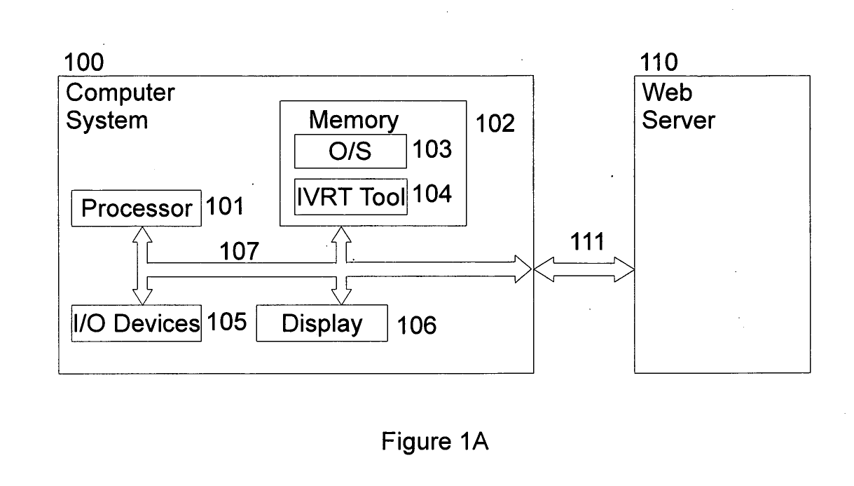

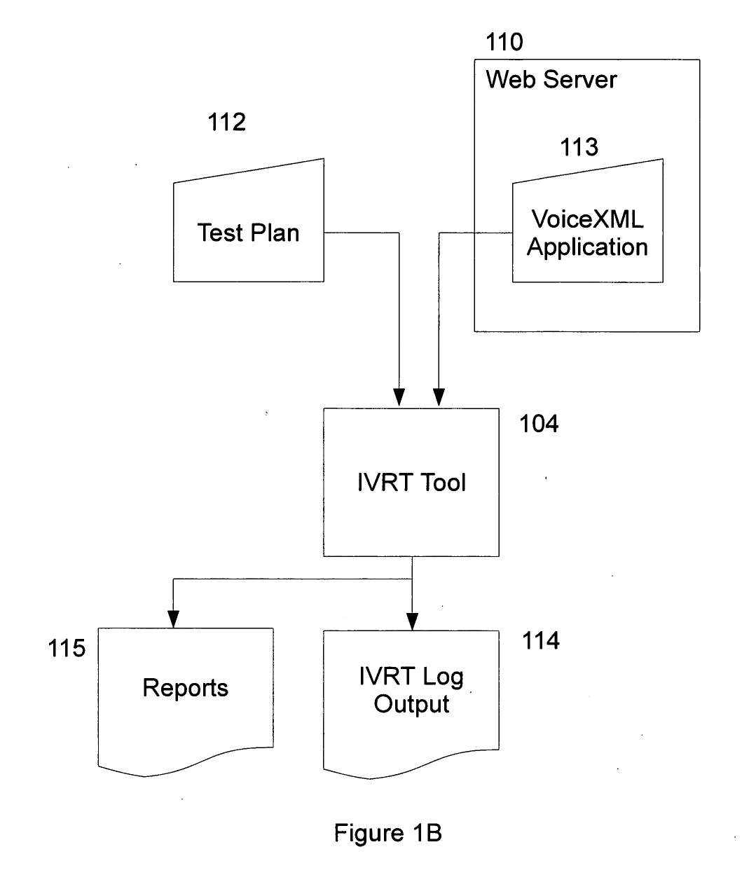

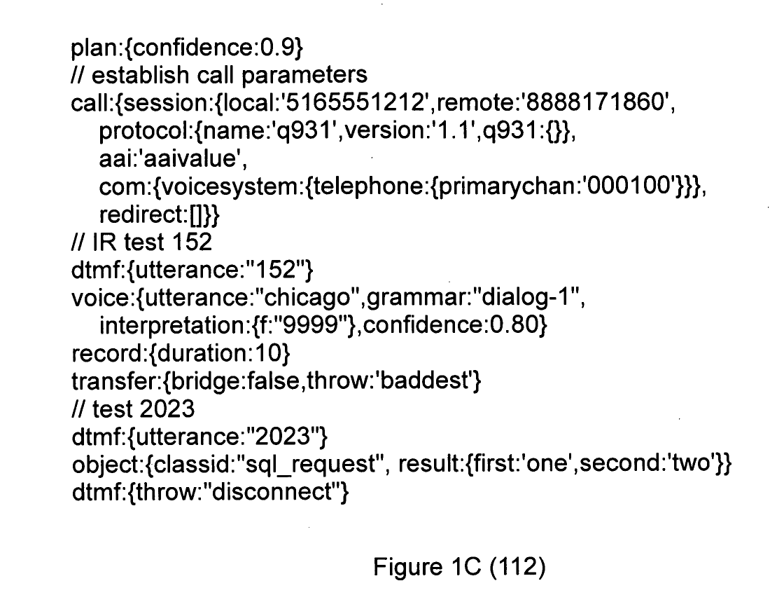

FIG. 1A shows the general execution requirements for the invention. A standard computer system (100) with a processor (101) that has access (107) to memory (102) into which an operating system (103) has been loaded, I/O devices (105), a display (106), and a web server (110) through a path (111) that is either internal to the computer or is a network connection to another host running the web server. With a standard computer as described, the invention (104) is loaded into memory and executed. The invention is not limited to a specific computer model. VoiceXML interpreters have been implemented on a number of different computer models.

The ideas of the invention are embodied in a computer program. In FIG. 1B, the invention executes in the computer system of FIG. 1A. The invention, IVRT (104), is provided with two forms of input, a Test Plan (112) and a VoiceXML application (113). The Test Plan is provided by a user of the invention, such as Quality Assurance staff member. The VoiceXML application originates from an application developer, and is accessed via a web server (110). The invention executes the VoiceXML application according to the Test Plan and writes the result of the execution as a log (114) which can be subsequently analyzed and used in further activities such as regression testing. Supplementary reports (115) are optionally written at the end of execution.

FIG. 1C shows a sample Test Plan (114) reflecting a variety of Test Plan statements, illustrating the syntax known as Javascript Object Notation. This syntax is familiar to VoiceXML developers as the ECMA-262 object literal notation. ECMA-262 is the specification of the scripting language embedded within the VoiceXML specification.

The invention, IVRT, executes the following steps to accomplish a Test Plan.
1) read and syntactically process the Test Plan; if there are any errors, list all errors in the output log and terminate
2) with a valid Test Plan, process an optional Plan statement to set global values that persist for the duration of Test Plan execution
3) process the next Call statement to establish parameters that apply to the next call; skip statements other than a Call statement, resynchronizing the Test Plan if necessary; if there is no Call statement, go to step 10)
4) begin execution of the VoiceXML application to be tested; this may entail fetching the application from a web server as indicated by the application's Universal Resource Locator (URL), a standard method of identifying and requesting resources from a web server
5) continue execution of the application, recording the sequence of VoiceXML elements for coverage, until execution comes to an input point, a prompt, or an exit; input points are represented by one of the following VoiceXML elements:
   a) initial
   b) field
   c) record
   d) transfer
   e) object
prompts are represented by a prompt element, audio element, or character content; an exit is represented by an exit element or the end of executable elements
6) to execute an exit, internally end the call and go to step 3)
7) to execute an input point, process the next Test Plan statement and match it to the application's input request; if there is a mismatch, log the error and go to step 3); otherwise, from the values in the Test Plan statement construct a response to the application's input request; go to step 9)
8) to execute a prompt, optionally examine the next Test Plan statement; if it is a Prompt statement, apply the assertion value to the value of the prompt and log the result; if there is no prompt statement in the Test Plan, log the value of the prompt and go to step 5)
9) continue executing the application using the constructed input response; this may involve one or more of the following actions, which are defined by the VoiceXML specification:
   a) activate the indicated grammar;
      VoiceXML has various scope levels at which grammars can be active; the Test Plan uses the scope name and sequence number as a trigger identifier, which in a live VoiceXML application is implicit in the response of a voice recognizer; this is one of the design aspects that allow the invention to eliminate speech from the testing process
   b) assign values to shadow variable properties
   c) assign values to application scope properties
   d) assign values to form item variables
   e) throw a VoiceXML event
in this manner, the VoiceXML input request is satisfied by the Test Plan statement; go to step 5)
10) terminate IVRT by writing any requested reports and exiting the program

Coverage reports are generated from the accumulation of data regarding the VoiceXML elements being executed in step 5).

Regression testing validates an updated application by verifying that its past performance has not been altered by the updates. A given VoiceXML application and Test Plan should always yield the same output. Thus, the IVRT log of an updated application can be compared programmatically to the log of a previous version of the application executing the same Test Plan. The log should be identical, and if not, the differences are quickly highlighted by the comparison.

### SUMMARY OF TEST PLAN STATEMENTS

| Statement | Purpose |
|---|---|
| plan | establishes options and values for the entire Test Plan |
| call | provides a synchronization point in the Test where a new call |
| | is started; provides values to be associated with the call's |
| | session object (defined by VoiceXML) |
| dtmf | provides data used by a VoiceXML field element expecting |
| | DTMF input |
| voice | provides data used by a VoiceXML field element expecting |
| | voice input |
| record | provides data used by a VoiceXML record element in order to |
| | create a voice recording |
| transfer | provides data used by a VoiceXML transfer element to |
| | communicate the outcome of a call transfer |
| object | provides data returned from a VoiceXML object element |
| delay | inserts a delay in the execution of a Test Plan |
| prompt | an assertion of prompt contents at various points in the Test |
| | Plan |
| annotate | put an annotation in the output log |

### BACKGROUND OF THE INVENTION

The invention generally relates to the field of Software Quality Assurance for VoiceXML applications. Briefly, Software Quality Assurance is the verification of software correctness. VoiceXML applications are Interactive Voice Response applications which provide automated services and information over a telephony connection, either through the Public Switched Telephone Network or through the Internet via Voice-Over-IP technology. VoiceXML is a language developed as a consensus industry standard by the Worldwide Web Consortium, the W3C, with the participation of a number of major IVR vendors. VoiceXML embeds another language called ECMAScript (standardized by the European Computer Manufacturers Association as ECMA-262), which is commonly called an embedded scripting language. This is conceptually the same language embedded by web browsers and known as Javascript. VoiceXML execution platforms are offered for sale by every major IVR vendor.

Common IVR application testing is usually done by a person at a telephone with a test script. The person performs the test by making call after call following the script and marking any application behavioral deviance from the specification in the script. This is a manual process and sometimes a subjective one. It can take many hours for a complicated application, and because of the time, efforts, and resources involved, it is rarely repeated when the application is changed or enhanced, or when other aspects of the application's execution environment change (regression testing).

VoiceXML testing is further complicated because VoiceXML applications depend upon the execution of web servers in the same way that web browsers depend upon web servers. Some expository documents about VoiceXML further this analogy by referring to a program that executes VoiceXML applications as a “voice browser.” A VoiceXML application must be served by a web server and most often involves the execution of web logic as an integral part of the application execution.

Therefore, what is needed is a method to remove the person from the testing process, to control the test by a machine-readable test script making it precisely repeatable, provide the script with enough flexibility so that every aspect of the application can be exercised by the script, provide auxiliary functions so that the application behavior can be internally verified (assertions), provide multiple execution instances so that the web logic can be verified under load, and provide reporting and comparison features to support application coverage and automated regression testing.

### SUMMARY OF THE INVENTION

The invention is known by the initials IVRT. With IVRT, the test script described above becomes a program-readable description of the test. The test can represent any number of telephone calls, each of which provides different telephony inputs to the application being tested. This allows the application logic to be extensively exercised. With IVRT, the need for speech in the application testing is eliminated and the test is run at computer speed, faster than real-time, allowing more testing to be done in less time.

The Test Plan is written in the syntax used for ECMAScript object literals, also known in the industry as Javascript Object Notation (JSON). The VoiceXML standard embeds ECMAScript and thus the ECMAScript object literal notation is familiar to VoiceXML application developers. The creation of a Test Plan therefore does not impose a new syntax learning requirement on a developer. The Test Plan is a text file that can be prepared with any text editor. Only a minimum amount of description is required for each Test Plan statement. IVRT will assume common defaults for information not supplied.

IVRT is an enhanced VoiceXML interpreter, that is it executes (interprets) VoiceXML applications. But instead of interfacing with telephone callers, it is directed by the Test Plan, which provides telephony for the application. The application is not aware that its telephony interactions are not the result of a real call. The expected telephony responses are read from the Test Plan. The execution behavior of the application is logged for further analysis.

All other aspects of VoiceXML execution are live. IVRT interfaces with web servers in the manner specified by the VoiceXML standard, and the applications therefore sees a live web environment, so that execution under control of the Test Plan uses the same web logic that the application will execute in a live environment with real telephony.

The primary output of IVRT is the log of the Test Plan execution. This log must be examined by the developer to determine if the application executed the test correctly. Error messages are identified by specific codes that are easy to find. The developer can place assertions in the Test Plan, and failures will also stand out. After a Test Plan has been successfully executed, the log of the Test Plan becomes the primary input to future iterations of regression testing.

Regression testing occurs when the application is subsequently updated, or the application's execution environment changes. The original Test Plan is run with the changes for a regression test. The logged output of this test can be compared with IVRT to the previous archived log to quickly verify correct regression behavior. This verifies that the changes did not alter the application's behavior under the original Test Plan. Then, if the application was updated, the Test Plan can be updated to reflect the application updates and a new regression baseline can be created with another test run, using the updated test plan. The updated application can then be put into production with the knowledge that it has been regression tested and is upward compatible. The updated Test Plan and the new regression baseline are archived for the next round of regression tests.

A secondary IVRT output is a coverage report. This report notes those logic paths of the application which were executed by the Test Plan and those that were not. This provides a Software Quality Assurance measure of the extensiveness of the Test Plan, and therefore an indication of what logic paths in the application still remain to be tested. VoiceXML is a nested language, and the coverage report provides the frequency of execution for each level in a VoiceXML document's hierarchy, for each document instance that was involved in the test. The document instances can be merged or displayed individually for each time they are invoked.

The technical advantage achieved by the invention is the automation of VoiceXML quality assurance testing, providing savings in time and resources, with the added advantages of precise test replication, test coverage reporting, and regression testing.

1. A method for quality assurance testing of one or more simultaneous instances of a VoiceXML application in super-real-time by obtaining the telephony interactions expected by the application from a test plan, eliminating the need for speech input or output during execution, and providing a speed improvement over normal real-time testing.

2. A method of claim 1 whereby the execution of the VoiceXML application is controlled by a Test Plan, a series of directives which provide information for simulated telephony interactions and speech responses, encompassing any number of simulated telephone calls, allowing each call to provide differing interactions and thus test different aspects of the application.

3. A method of claim 2 wherein in Test Plan directives provide for grammar triggers, interpretations, and multiple results, eliminating the need for speech to test VoiceXML application logic.

4. A method of claim 2 wherein Test Plan directives can also provide assertions about the expected behavior of the application, checks that specific logical conditions are true at specific points in a test.

5. A method of claim 2 wherein Test Plan directives can also provide metadata applicable to all calls.

6. A method of claim 2 whereby the Test Plan syntax reflects the syntax used within VoiceXML (ECMAScript) and is therefore familiar to VoiceXML developers.

7. A method of claim 1 wherein all actions of the VoiceXML application during the execution are logged to become input to subsequent regression testing.

8. A method of claim 1 wherein all executed logic paths of the application during the execution are recorded to provide a Quality Assurance measure known as “Coverage”, the effectiveness of a test as measured by the percentage of logic paths executed.

9. A method for comparing the logged output of separate Test Plan executions so that the irrelevant differences, such as time stamps, are ignored, and the relevant aspects of the logging are compared to provide support for Quality Assurance regression testing. Log differences and their points of occurrence are highlighted.
